(19) United States
(12) Patent Application Publication
(10) Pub. No.: US 2016/0118928 A1
(43) Pub. Date: Apr. 28, 2016

(54) COLLAPSIBLE CONTAINMENT SHIELD FOR SOLAR ENERGY PANELS

(71) Applicant: Pegasus Solar Inc., Richmond, CA (US)

(72) Inventors: Erich Kai Stephan, Newport Beach, CA (US); Glenn Harris, Sausalito, CA (US)

(21) Appl. No.: 14/919,447

(22) Filed: Oct. 21, 2015

Related U.S. Application Data
(60) Provisional application No. 62/067,293, filed on Oct. 22, 2014.
(60) Provisional application No. 62/067,295, filed on Oct. 22, 2014.

(51) Int. Cl. H02S 20/30

(52) U.S. Cl. CPC H02S 20/30

(57) ABSTRACT

Collapsible solar energy panel assemblies including containment shields for covering an opening made between the solar energy panel and an installation surface.

### CROSS REFERENCE TO RELATED APPLICATIONS

This application claims priority to U.S. Provisional application No. 62/067,293, filed on Oct. 22, 2014, which is entitled “COLLAPSIBLE CONTAINMENT SHIELD FOR SOLAR ENERGY PANELS,” and to U.S. Provisional application No. 62/067,295, filed on Oct. 22, 2014, which is entitled “INTEGRATED SUPPORT BEAM,” each of which are expressly incorporated by reference herein in their entireties.

### BACKGROUND

1. Technical Field

The present technology relates to containment systems for solar energy panels.

2. Introduction

Solar energy panels are becoming an increasingly popular method to provide electrical and thermal energy to society. In many instances, the solar energy panels are installed at some distance or some angle relative to an installation surface, creating an open area between the solar energy panel and the installation surface, such as a rooftop, the ground, a foundation, or the like. In many areas, it is desirable or necessary to close off this vacant space in order to prevent airflow from pushing upwards on the solar energy panels, to prevent the spread of flames to the underside of a solar energy panel during a fire incident, to shade wires or electrical equipment from ultraviolet light, or to improve aesthetics. The present system to accomplish these goals includes installing a pane of metal or plastic around the open space after the solar energy panels have been installed on the installation surface.

### SUMMARY

The disclosed technology involves solar energy panel assemblies. Embodiments of the disclosed technology involve both framed and frameless solar energy panel assemblies. The solar energy panel assemblies can involve a photovoltaic panel mounted lateral edges or support beams that support the photovoltaic panel and extend substantially the length of the photovoltaic panel. The solar energy panel assemblies can also include hinge brackets that are coupled with the ends of the lateral edges and support beams and that rotate up and down to put the photovoltaic panel in an installation position at an angle relative to an installation surface and alternatively in a collapsed position for storing and transportation.

When the solar energy panel assemblies are in an installed position, an opening is created between the lateral edges/support beams and the installation surface. So, a containment shield is coupled with hinge brackets or photovoltaic panel to cover the opening. Likewise, a side cover containment shields cover the side opening between the lateral edges/support beams and the installation surface.

The containment shield can be rotatably coupled to the hinge brackets such that the containment shield can be opened and closed thereby exposing the opening made between the lateral edges/support beams and the installation surface.

In some embodiments of the present technology, the hinge brackets and containment shield are configured such that their combined thickness, when rotated in a position that is substantially parallel with the lateral edges/support beams, is less thick than the lateral edges/support beams themselves, thereby preventing the hinge brackets and containment shield from extending outside of the profile made by lateral edges/support beams and allowing the solar energy panel assemblies to be stackable for transport, storage, etc.

The solar energy panel assemblies can also include an electronics module (e.g. an electrical junction box) coupled with the photovoltaic panel that is substantially covered by the containment shield when the hinge brackets are rotated to be substantially parallel with the lateral edges/support beams. The containment shield can also include an attachment point for holding one or more accessories (e.g. a micro-inverter, DC optimizer, etc) for operating the photovoltaic panel.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A and 1B illustrate a frameless solar energy panel assembly according to some embodiments of the present technology;

FIG. 1C illustrates a solar energy panel assembly with a hinge braces and hinge brackets for putting the solar energy panel at certain predetermined positions according to some embodiments of the present technologypresent technology;

FIG. 1D shows the solar energy panel with an opening containment shield according to some embodiments of the present technologypresent technology;

FIG. 2A shows a solar energy panel with a containment shield collapsed to be substantially parallel with solar energy panel according to some embodiments of the present technologypresent technology;

FIG. 2B illustrates multiple solar energy panels assemblies stacked on top of each other in a flat configuration according to some embodiments of the present technology;

FIG. 3 illustrates a solar energy panel with a containment shield and a side containment shield according to some embodiments of the present technology;

FIG. 4A illustrates a framed collapsible solar energy panel assembly with a containment shield according to some embodiments of the present technology;

FIGS. 4B-4C illustrates an underside of a framed collapsible solar energy panel assembly with a containment shield according to some embodiments of the present technology; and

FIG. 4D illustrates multiple framed solar energy panels assemblies stacked on top of each other in a flat configuration according to some embodiments of the present technologypresent technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

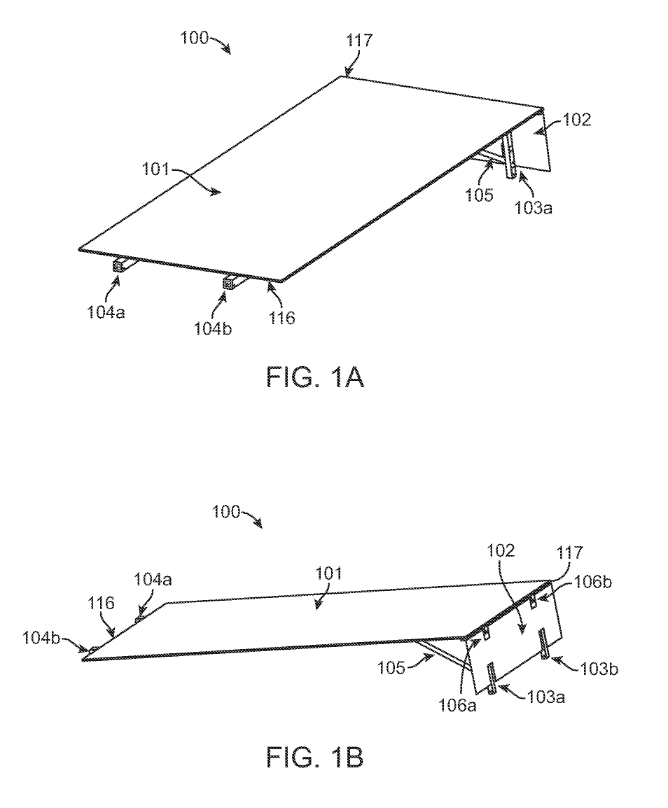

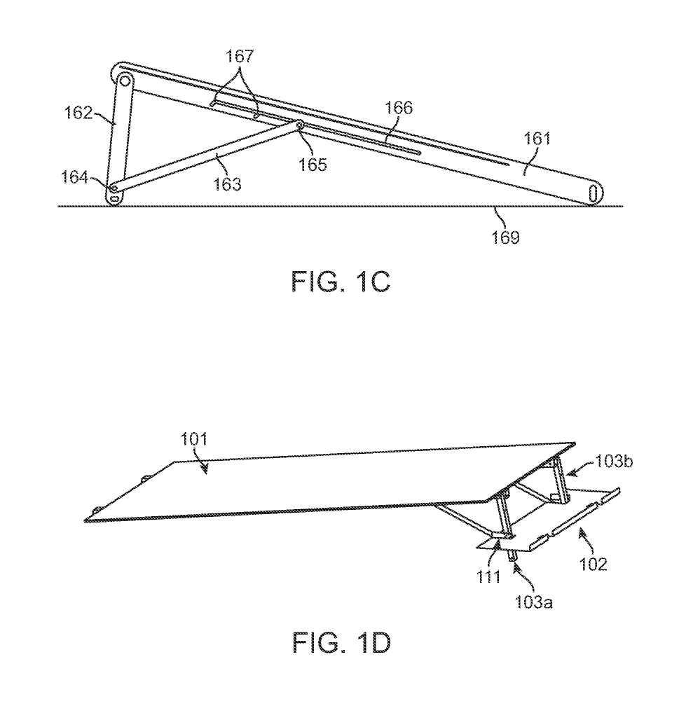

FIGS. 1A and 1B illustrate a frameless solar energy panel assembly 100 according to some embodiments of the present technology. The solar energy panel assembly 100 includes a solar energy panel 101 coupled with support beams 104ₐ and 104_{b} that can extend the length of the solar energy panel 101. Additionally, the support beams 104ₐ and 104_{b} can extend past the end 116 of the solar panel 101 and can be configured to couple with an installation surface, an installation assembly on the installation surface, etc. In some cases, the ends of the support beams 104ₐ and 104_{b} that extend past the end 116 of the solar panel 101 are configured to be rotatably coupled with an installation assembly on the installation surface, such that the frameless solar panel assembly 100 can be lifted (e.g. at the other end 117 of the solar panel) and rotated away from the installation surface.

The solar energy panel assembly 100 can also include hinge brackets 103ₐ and 103_{b}, and a collapsible containment shield 102. The hinge brackets 103ₐ, 103_{b} can be rotatably coupled to the support beams 104ₐ and 104_{b} with a bolt, screw, rivet, pin, etc. and the hinge brackets 103ₐ, 103_{b} can rotate between positions that are substantially perpendicular to the support beams 104ₐ and 104_{b} and to positions that are substantially parallel with the support beams 104ₐ and 104_{b}. In some embodiments, the hinge brackets 103ₐ, 103_{b} can rotate into a position that is between the support beams 104ₐ and 104_{b} and substantially co-planar with the support beams 104ₐ and 104_{b}. Additionally, the hinge brackets 103ₐ, 103_{b} can be as thick or less thick than the support beams 104ₐ and 104_{b} so that the hinge brackets 103ₐ, 103_{b} do not extend away from the solar panel farther than the support beams 104ₐ and 104_{b}, thereby allowing a stack of solar energy panel assemblies to remain flat during shipping, storage, in the field, etc.

The solar energy panel assembly 100 shown in FIGS. 1A-1B also includes hinge braces 105ₐ, 105_{b} (not shown) that couples with the support beams rotatably coupled 104ₐ and 104_{b} and with the hinge bracketsl03ₐ, 103_{b}. The hinge braces 105ₐ, 105_{b} may be permanently or semi-permanently connected on one end to the hinge brackets 103ₐ, 103_{b}. Alternatively, the hinge braces 105ₐ, 105_{b} may be temporarily connected with the hinge brackets 103ₐ, 103_{b} or the support beams 104ₐ and 104_{b} and can be removed at to facilitate the collapse of the solar energy panel assembly 100.

In some embodiments, the support beams 104ₐ and 104_{b} and the hinge braces 105ₐ, 105_{b} can be configured to substantially lock the hinge brackets 103ₐ, 103_{b} from articulating when the hinge brackets 103ₐ, 103_{b} are rotated in certain positions.

For example, FIG. 1C illustrates a solar energy panel assembly 160 with a hinge brace 163 configured to lock a hinge bracket 162 at certain predetermined positions according to some embodiments of the present technology. As shown in FIG. 1C, a support beam 161 of a solar energy panel assembly 160 includes a guide slot 166 with multiple internal indentations 167. A hinge brace 163 can be slidably coupled with the guide slot, e.g. via a pin 165 and can be rotatably coupled with a hinge bracket 162, e.g. via a joint 164. The hinge bracket 162 can rotate from a position that is substantially parallel with the lateral edge (e.g. when the hinge brace 163 slides the pin 165 to the terminal end of the guide slot) to multiple positions for supporting the support beam 161 at an angle to the installation surface 169. At some positions, the internal indentations 167 can accommodate the pin 165 to lock the hinge brace 163 and hinge bracket 162.

Referring again to FIGS. 1A-1B, the hinge brackets 103ₐ, 103_{b} are in a position such that the solar energy panel assembly is at an angle relative to the installation surface (not shown), which creates an opening between the solar energy panel and the underlying installation surface. Accordingly, the solar energy panel assembly 100 includes a containment shield 102 to cover the opening. The containment shield 102 can be shaped to fit any shaped opening is created between the solar energy panel 101 and the installation surface.

The containment shield 102 can be a formed piece of flat metal, such as sheet metal, or made from a fiberglass, a plastic material, combinations of metal, fiberglass, and plastic, etc. A metal construction can provide increased strength and low manufacturing costs while a fiberglass or plastic material allows for complex shapes to be molded in the manufacturing process, such as tabs, hooks, flanges, screw holes, or perforations. Additionally, the fiberglass or plastic material acts as an electrical insulator, preventing the need for grounding or bonding the containment shield to an electric ground source.

The containment shield may have flanges protruding substantially orthogonal to the main surface to allow for the connection to the solar energy panel, or connection to one or more articulating beams. Additionally, the containment shield may have hemmed edges, rounded edges, or tabs on one or more perimeter edges to prevent a sharp edge from being exposed to nearby wires, electronics, and for easy handling.

The containment shield 102 reduces airflow under the solar energy panel 101 and, thereby, reduces the spread of flame under the solar energy panel assembly 101 in the case of a fire. The containment shield 102 can also protect wiring, inverters, etc. (not shown) coupled to or housed under the solar energy panel assembly 100 as well as the roof membrane (e.g. a water barrier that may be compromised when a solar energy panel is installed) and any other solar system or building components. In addition, the containment shield 102 improves the structural rigidity of the solar energy panel assembly 100.

In some embodiments, the containment shield 102 is connected to solar energy panel 101 using one or more of the hinge brackets 103ₐ, 103_{b} where the one side of a hinge bracket is welded, glued, riveted, or fastened to a containment shield, and the other side of a hinge bracket is welded glued, riveted, or fastened to a solar energy panel 101 or a solar energy panel's exterior frame. Additionally, the hinge interface may be formed into the containment shield 102 itself, and the opposite hinge component may be glued, welded, adhered, riveted, or similarly fastened to solar energy panel 101. The containment shield 102 may be the same width of solar energy panel 101, or may be of a greater or lesser width of the solar energy panel 101. The containment shield 102 can have a substantially similar width in order to maintain a substantially contained volume under one or more solar energy panels 101 when multiple solar energy panels are disposed next to one another. The edges of containment shield 102 may be straight, or may have a formed edge or hem to increase the stiffness, reduce sharp edges, and improve the handling ability during assembly and use.

Referring to FIG. 1B, the containment shield 102 is installed on a solar energy panel assembly 100 and secured to one or more of the hinge brackets 103ₐ, 103_{b}. The containment shield 102 may be secured to a bottom edge of the hinge brackets 103ₐ, 103_{b} with a fastener, and may be secured on the top-side with fasteners through hinge brackets 103ₐ, 103_{b} at locations 106ₐ, 106_{b}.

In some embodiments of the present technology, the containment shield 102 is rotatably coupled with the hinge brackets 103ₐ, 103_{b} to allow the containment shield 102 to be moved after the solar energy panel is installed on an installation surface to allow an operator access to the underside of the solar energy panel 101. For example, in some embodiments, the top-side fasteners at locations 106ₐ, 106_{b} can be removable such that a set of lower fasteners can be an axis of rotation for the containment shield 102.

FIG. 1D shows the solar energy panel 101 from FIG lA with the containment shield 102 rotated around lower connection fastener 111, which may be a bolt, screw, rivet, pin, or similar device. In this configuration, the lower connection fastener 111 has a dual purpose of securing the containment shield to hinge brackets 103ₐ, 103_{b} and also acting as an axis point for the containment shield to rotate around. The containment shield may rotate to be substantially perpendicular to hinge brackets 103ₐ, 103_{b}. The ability to rotate containment shield 102 after hinge brackets 103ₐ, 103_{b} are fixed in an installation position allows for the access to the backside of containment shield 102 or the underside of solar energy panel 101. The solar energy panel assembly 100 can also include an electronics module (not shown) that is coupled to the solar energy panel 101 or attached to the containment shield 102 and that can be accessed by rotating the containment shield 102.

Additionally, the containment shield 102 can be configured to rotate with the hinge brackets 103ₐ, 103_{b}, e.g. via rotating about the top-side fastener at locations 106ₐ, 106_{b}. As explained above, the hinge brackets 103ₐ, 103_{b} can be collapsible and can be as thick or less thick as the support beams 104ₐ, 104_{b} of such that, when in a collapsed position, the hinge brackets 103ₐ, 103_{b} are substantially parallel with the support beams 104ₐ, 104_{b} of the solar energy panel assembly 100 and the hinge brackets 103ₐ, 103_{b} do not extend away from the solar panel farther than the support beams 104ₐ and 104_{b}. Likewise, the containment shield 102 can also be substantially flat and can maintain the substantially parallel orientation the collapsed solar energy panel assembly 100. Furthermore, the containment shield 102 can be configured with a thickness that, together with the thickness of the hinge brackets 103ₐ, 103_{b}, does not extend away from the solar panel farther than the support beams 104ₐ and 104_{b}, thereby allowing a stack of solar energy panel assemblies to remain flat during shipping, storage, in the field, etc.

This collapsible, substantially planar orientation of the present technology has several advantages over existing art. First, the present technology provides the ability to reduce the area occupied by the solar energy panel 101 with the containment shield 102 installed when the hinge brackets 103ₐ, 103_{b} and the containment shield 102 are collapsed to be substantially parallel with the solar energy panel 101. The present technology also enables the containment shield 102 to be installed at a factory, warehouse, staging area, or the like, and occupy substantially the same or minimally greater volume during shipping, storage, transportation, etc. as compared to a solar energy panel assembly with no containment shield installed. Also, installing the containment shield 102 at a factory, warehouse, staging area, or the like, provides advantages in labor savings, material savings, quality improvement, and time savings during final installation of the solar energy panel assembly 100 on an installation surface.

The containment shield 102 can also include attachment points for accessories, (including accessories for securing wiring from the solar energy panel), pipes, inverters, micro-inverters, DC optimizers, batteries, electrical charging device, weather monitoring, or any other useful accessories. In some embodiments, accessories having a low profile can be installed on the face of the containment shield 102 facing the solar energy panel 101 and remain in position when the containment shield 102 is collapsed to be substantially parallel with the solar energy panel 101. This technology enables the accessories to be installed with the containment shield 102 and solar energy panel 101 at a factory, warehouse, staging area, or the like, and occupy substantially the same or minimally greater volume during shipping, storage, transportation, etc. as compared to a solar energy panel with no accessories nor containment shield installed. Installing the accessories at a factory, warehouse, staging area, or the like, provides advantages in labor savings, material savings, quality improvement, and time savings during final installation of the solar energy panel 101 on an installation surface.

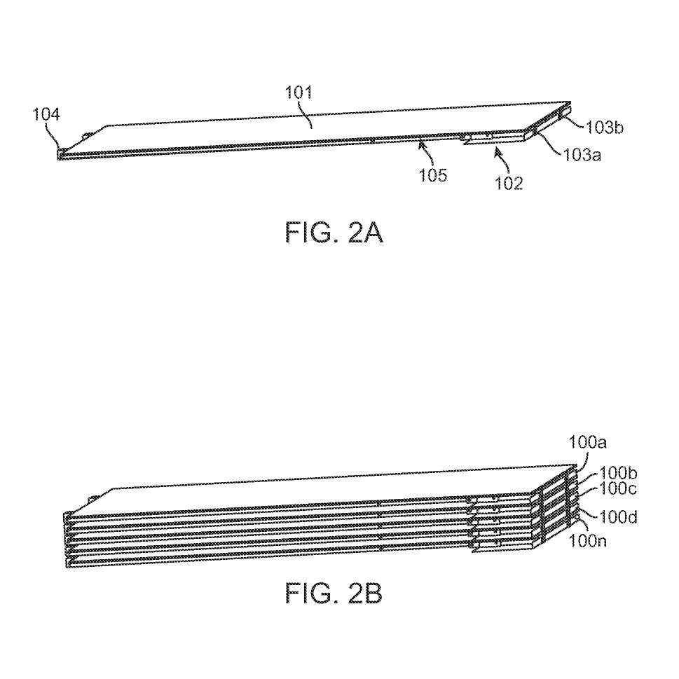

FIG. 2A shows a solar energy panel 101 with a containment shield 102 collapsed to be substantially parallel with solar energy panel 101. The hinge brackets 103ₐ, 103_{b} are rotated to be substantially parallel with solar energy panel 101, thereby articulating containment shield 102 to also be substantially parallel with solar energy panel 101. Hinge brace 105 may be secured in a second position on one of the support beams 104ₐ, 104_{b} to substantially prevent the hinge brackets 103ₐ, 103_{b} or containment shield 102 from rotating relative to solar energy panel 101 during shipping, installation, etc. FIG. 2B illustrates multiple solar energy panels assemblies 100ₐ, 100_{b}, 100, 100_{d}, . . . , 100ₙ from FIG. 2A stacked on top of each other in a flat configuration for reduced volume during inventory, shipment, storage, etc.

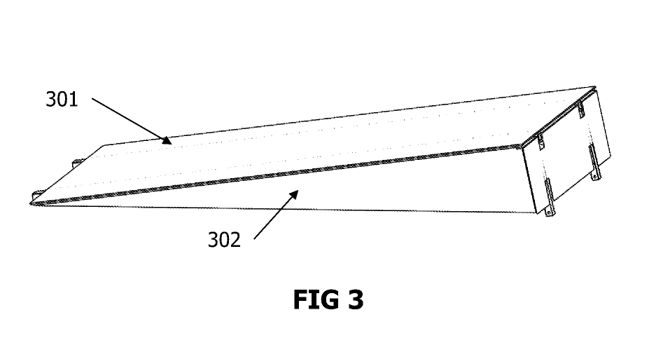

As explained above, a containment shield can reduce airflow under the solar energy panel, can protect other components under the solar energy panel, can improve the structural rigidity of the solar energy panel assembly, etc. In some embodiments, the solar energy panel assembly also includes a side containment shield for further closing the underside of the assembly. FIG. 3 illustrates a solar energy panel 301 with side containment shield 302. In this example embodiment, side containment shield 302 may be secured to solar energy panel 301 via a hinge bracket. The side containment shield 302 may be substantially triangular or rectangular in shape, or may be some other shape to contain the volume of space disposed below solar energy panel 201. The side containment shield 302 may connect, be coincident, or may allow a gap relative to all the containment shield 302, the solar energy panel 301, or an underlying installation surface below its lower edge. The side containment shield 302 may be one or more pieces of material, and may be solid or perforated. Also, the side containment shield 302 may have a shear edge, or one or more edges may be hemmed, bent over, or formed to reduce a sharp edge and increase stiffness.

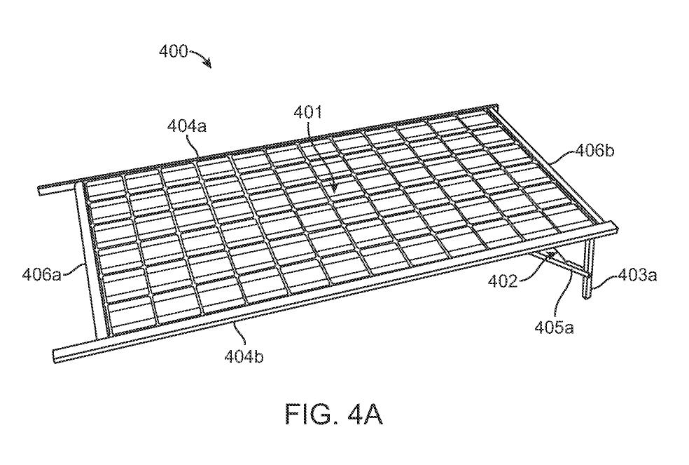

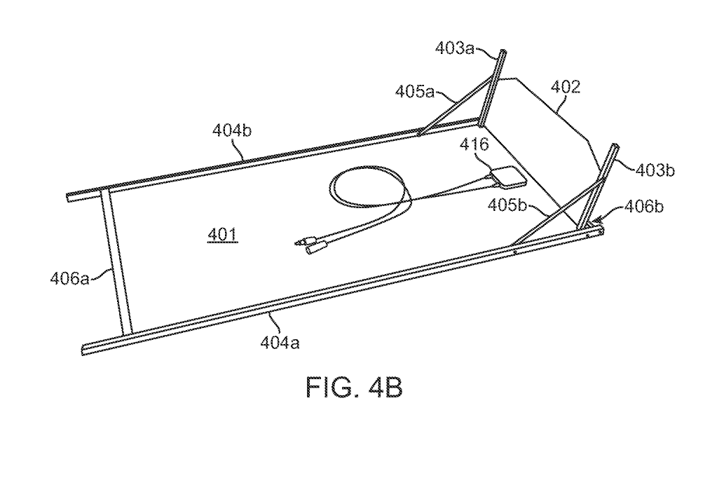

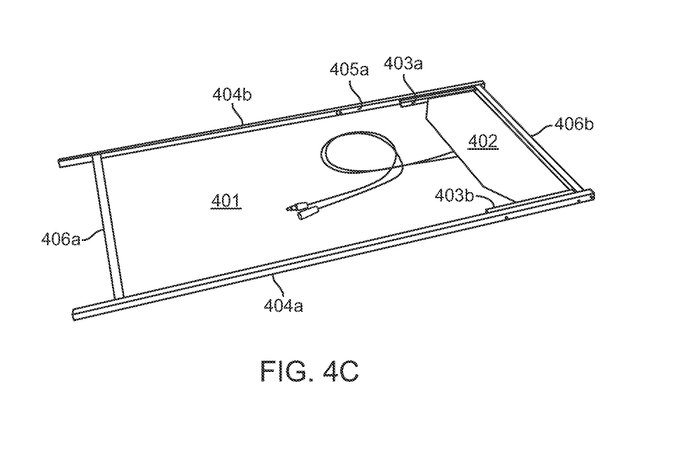

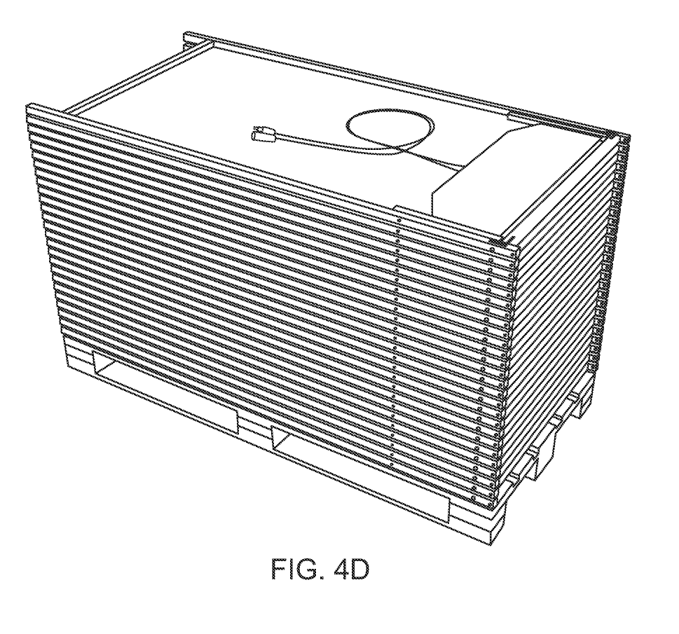

Some embodiments of the present technology also involve collapsible, framed solar panel assemblies. FIG. 4A illustrates a framed solar energy panel assembly 400 including a solar energy panel 401 framed by lateral edges 404ₐ and 404_{b} and terminal edges 406ₐ and 406_{b}. The lateral edges 404ₐ and 404_{b} can extend past the terminal edges 405ₐ and can be configured to couple with an installation surface, an installation assembly on the installation surface, etc.

The solar energy panel assembly 400 can also include hinge brackets 403ₐ and 403_{b}, and a collapsible containment shield 402.

As shown in FIGS. 4B-4C, the hinge brackets 403ₐ, 403_{b} can be rotatably coupled to the inside of the lateral edges 404ₐ and 404_{b} and can rotate between positions that are substantially perpendicular (FIG. 4B) to the lateral edges 404ₐ and 404_{b} and to positions that are substantially parallel (FIG. 4C) with the lateral edges 404ₐ and 404_{b}. Additionally, the hinge brackets 403., 403_{b} can be as thick or less thick than the lateral edges 404ₐ and 404_{b} so that the hinge brackets 403ₐ, 403_{b} remain enveloped in the dimensions of the lateral edges 404ₐ and 404_{b} and terminal edges 406ₐ and 406_{b}, thereby allowing a stack of solar energy panel assemblies to remain flat during shipping, storage, in the field, etc. The solar energy panel assembly 400 can also include an electronics module 416 that is coupled to the solar energy panel 401. For example, the electronics module 416 can be an electrical junction box.

The solar energy panel assembly 400 shown in FIGS. 4A-4D also includes hinge braces 405ₐ, 405_{b} that couples with the lateral edges 404ₐ and 404_{b} and with the hinge brackets 403., 403_{b}. In some embodiments, the lateral edges 404ₐ and 404_{b} and the hinge braces 405ₐ, 405_{b} can be configured to substantially lock the hinge brackets 403ₐ, 403_{b} from articulating when the hinge brackets 403ₐ, 403_{b} are rotated in certain positions.

Also, the solar energy panel assembly 400 includes a containment shield 402 coupled with the hinge brackets 403ₐ, 403_{b} to cover the opening made between the solar energy panel 401 and the installation surface when the hinge brackets 403ₐ, 403_{b} are rotated into a supporting position.

The containment shield 402 reduces airflow under the solar energy panel 401 and, thereby, reduces the spread of flame under the solar energy panel assembly 101 in the case of a fire. The containment shield 102 can also protect wiring, inverters, etc. (not shown) coupled to or housed under the solar energy panel assembly 100 as well as the roof membrane (e.g. a water barrier that may be compromised when a solar energy panel is installed) and any other solar system or building components. In addition, the containment shield 102 improves the structural rigidity of the solar energy panel assembly 100.

In some embodiments of the present technology, the containment shield 402 is rotatably coupled with the hinge brackets 403ₐ, 403_{b} to allow the containment shield 402 to be moved in the field to allow an operator access to the underside of the solar energy panel 401. Additionally, the containment shield 402 can be configured to rotate with the hinge brackets 403ₐ, 403_{b}. The containment shield 402 can also be substantially flat can be configured with a thickness that, together with the thickness of the hinge brackets 403ₐ, 403_{b}, does not extend away from the solar panel farther than the support beams 404ₐ and 404_{b}, thereby allowing a stack of solar energy panel assemblies to remain flat during shipping, storage, in the field, etc. FIG. 4D illustrates multiple framed solar energy panel assemblies from FIGS. 4A-4C stacked on top of each other in a flat configuration for reduced volume during inventory, shipment, storage, etc.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A collapsible photovoltaic frame assembly comprising:
a photovoltaic panel mounted to a frame having a first lateral edge and a second lateral edge each secured to the photovoltaic panel and extending substantially the length of the photovoltaic panel and terminating at a terminal end;
a first hinge bracket and a second hinge bracket respectively rotatably coupled substantially at the terminal end of the first lateral edge and the second lateral edge, wherein the first hinge bracket and the second hinge bracket can be rotated from being substantially parallel with the first lateral edge and the second lateral edge to one or more positions for supporting the photovoltaic panel in an angled position relative to an installation surface; and
a containment shield coupled with the first hinge bracket and the second hinge bracket, wherein the containment shield rotates with the first hinge bracket and second hinge bracket and substantially covers an opening made between the terminal ends of the first lateral edge and the second lateral edge and the installation surface when the first hinge bracket and second hinge bracket are rotated to support the photovoltaic panel in an angled position relative to an installation surface.

2. The collapsible photovoltaic frame assembly of claim 1, wherein the first hinge bracket and second hinge bracket are rotatably coupled on an edge of the terminal end of the first lateral edge and the second lateral edge, and wherein the first hinge bracket and the second hinge bracket are not thicker than first lateral edge and the second lateral edge such that, when the first hinge bracket and the second hinge bracket are rotated in a position that is substantially parallel with the first lateral edge and the second lateral edge, the first hinge bracket and the second hinge bracket do not extend away from the photovoltaic panel further than first lateral edge and the second lateral edge.

3. The collapsible photovoltaic frame assembly of claim 2, wherein the first hinge bracket and the second hinge bracket are less thick than first lateral edge and the second lateral edge, and wherein the containment shield has a thickness such that, when the first hinge bracket, the second hinge bracket, and the containment shield are rotated in a position that is substantially parallel with the first lateral edge and the second lateral edge, neither the first hinge bracket, the second hinge bracket, nor the containment shield extend away from the photovoltaic panel further than first lateral edge and the second lateral edge.

4. The collapsible photovoltaic frame assembly of claim 1, wherein the containment shield is releasably coupled to one end of the first hinge bracket and a same end of the second hinge bracket and rotatably coupled to an opposing end of the first hinge bracket and second hinge bracket, wherein the containment shield can be released from one end of the first hinge bracket and second hinge bracket and rotated to an opened position, thereby exposing the opening made between the first lateral edge, the second lateral edge, and the installation surface.

5. The collapsible photovoltaic frame assembly of claim 4, wherein the containment shield further comprises an attachment point for holding one or more accessories for operating the photovoltaic panel, wherein the one or accessories is accessible the containment shield is released from the one end of the first hinge bracket and the second hinge bracket and rotated to the opened position.

6. The collapsible photovoltaic frame assembly of claim 1, further comprising:
a first hinge brace and a second hinge brace each having a fixed length and having first and second ends and respectively pivotally affixed to the first hinge bracket and second hinge bracket and respectively engaging a plurality of positions of the lateral edges of the frame at the connecting bars second ends, wherein the first hinge brace and second hinge brace engage with the first lateral edge and the second lateral edge allows the first and second legs to adjustably support the photovoltaic panel with respect to an installation surface at a plurality of angles.

7. The collapsible photovoltaic frame assembly of claim 6, wherein the first hinge brace and second hinge brace are configured to allow a zero angle between the photovoltaic panel and the installation surface.

8. The collapsible photovoltaic frame assembly of claim 6, wherein the first lateral edge and the second lateral edge respectively have a first aperture and second aperture, wherein the first aperture and second aperture are configured to engage the first hinge brace and second hinge brace, respectively, and support the first hinge bracket and a second hinge bracket in supporting the photovoltaic panel in an angled position relative to an installation surface.

9. The collapsible photovoltaic frame assembly of claim 8, further comprising pins extending from the first hinge brace and second hinge brace and a plurality of indentations in the apertures to receive said pins, thereby allowing the first hinge bracket and a second hinge bracket to support the photovoltaic panel in an angled position relative to an installation surface.

10. The collapsible photovoltaic frame assembly of claim 8, wherein the apertures are guide slots and the first hinge brace and second hinge brace can be stabilized at a plurality of points in the guide slots.

11. The collapsible photovoltaic frame assembly of claim 1, further comprising:
an electrical junction box coupled with the photovoltaic panel and substantially covered by the containment shield when the first hinge bracket and second hinge bracket are rotated to be substantially parallel with the first lateral edge and second lateral edge.

12. A collapsible photovoltaic frame assembly of claim 1, wherein the containment shield, the first and the second hinge brackets are manufactured as a single formed component.

13. The collapsible photovoltaic frame assembly of claim 1, further comprising:
one or more side cover containment shields configured to couple to the first lateral edge, the second lateral edge and cover a side opening made between the first lateral edge, the second lateral edge, and the installation surface when the first hinge bracket and second hinge bracket are rotated to support the photovoltaic panel in an angled position relative to an installation surface.

14. A frameless photovoltaic solar panel assembly comprising:
a photovoltaic panel;
a first support beam coupled to be underside of the photovoltaic panel between the center and a first edge of the photovoltaic panel and extending substantially across the photovoltaic panel;
a second support beam coupled to be underside of the photovoltaic panel between the center and a second edge of the photovoltaic panel and extending substantially across the photovoltaic panel;
a first hinge bracket and a second hinge bracket respectively rotatably coupled to the first support beam and the second support beam, wherein the first hinge bracket and the second hinge bracket can be rotated from being substantially parallel with the first support beam and the second support beam to one or more positions for supporting the photovoltaic panel in an angled position relative to an installation surface; and
a containment shield coupled with the first hinge bracket and the second hinge bracket, wherein the containment shield rotates with the first hinge bracket and second hinge bracket and substantially covers an opening made between the first support beam and the second support beam and the installation surface when the first hinge bracket and second hinge bracket are rotated to support the photovoltaic panel in an angled position relative to an installation surface.

15. The frameless photovoltaic solar panel assembly of claim 14, wherein the first hinge bracket and second hinge bracket are rotatably coupled on a side of the terminal end of the first support beam and the second support beam, and wherein the first hinge bracket and the second hinge bracket are not thicker than first support beam and the second support beam such that, when the first hinge bracket and the second hinge bracket are rotated in a position that is substantially parallel with the first support beam and the second support beam, the first hinge bracket and the second hinge bracket do not extend away from the photovoltaic panel further than first support beam and the second support beam.

16. The frameless photovoltaic solar panel assembly of claim 15, wherein the containment shield has a thickness such that, when the first hinge bracket, the second hinge bracket, and the containment shield are rotated in a position that is substantially parallel with the first support beam and the second support beam, neither the first hinge bracket, the second hinge bracket, nor the containment shield extend away from the photovoltaic panel further than first support beam and the second support beam.

17. The frameless photovoltaic solar panel assembly of claim 14, wherein the containment shield is releasably coupled to one end of the first hinge bracket and a same end of the second hinge bracket and rotatably coupled to an opposing end of the first hinge bracket and second hinge bracket, wherein the containment shield can be released from one end of the first hinge bracket and second hinge bracket and rotated to an opened position, thereby exposing the opening made between the first support beam, the second support beam, and the installation surface.

18. The frameless photovoltaic solar panel assembly of claim 14, further comprising:
an electronics module coupled with the photovoltaic panel and substantially covered by the containment shield when the first hinge bracket and second hinge bracket are rotated to be substantially parallel with the first support beam and second support beam.

19. The frameless photovoltaic solar panel assembly of claim 14, wherein the containment shield further comprises an attachment point for holding one or more accessories needed for operating the photovoltaic panel.

20. The frameless photovoltaic solar panel assembly of claim 14, further comprising:
one or more side cover containment shields configured to couple to the first support beam, the second support beam and cover a side opening made between the first support beam, the second support beam, and the installation surface when the first hinge bracket and second hinge bracket are rotated to support the photovoltaic panel in an angled position relative to an installation surface.

21. The frameless photovoltaic solar panel assembly of claim 14, wherein the containment shield, the first support beam, the second support beam, the first hinge bracket, and the second hinge bracket are constructed of a substantially non-electrically conductive material.

22. The frameless photovoltaic solar panel assembly of claim 14, wherein the first support beam and the second support beam extend across a length or a width of the photovoltaic panel.
